(19) United States
(12) Patent Application Publication
(10) Pub. No.: US 2009/0027306 A1
(43) Pub. Date: Jan. 29, 2009

(54) DUAL DISPLAY APPARATUS

(76) Inventor: Kazuyoshi Kawabe, Yokohama (JP)

Correspondence Address: J. Lanny Tucker;Patent Legal Staff, Eastman Kodak Company, 343 State Street, Rochester, NY, 14650-2201, US

(21) Appl. No.: 12/169,689

(22) Filed: Jul. 9, 2008

(30) Foreign Application Priority Data
Jul. 25, 2007 (JP) 2007-193883

(51) Int. Cl. G09G 5/12; G09G 3/28; G09G 3/36

(52) U.S. Cl. 345/3.1; 345/60; 345/87

(57) ABSTRACT

A dual display apparatus includes two activable displays capable of displaying an image signal, wherein the two displays differ in display characteristics; and a way for activating one of the displays in accordance with properties of an image signal.

### CROSS-REFERENCE TO RELATED APPLICATION

This application claims priority of Japanese Patent Application No. 2007-193883 filed Jul. 25, 2007 which is incorporated herein by reference in its entirety.

### FIELD OF THE INVENTION

The present invention relates to a dual display apparatus comprising two displays each capable of displaying an image of an image signal.

### BACKGROUND OF THE INVENTION

Flat panel displays, typified by liquid crystal displays (LCDs) or plasma display panels (PDPs), make full use of their respective display characteristics, thereby having achieved high performance capabilities, and gained widespread acceptance among users.

For example, LCDs have been improved by increasing intensity of a backlight or enhancing color purity to enable display of further brighter and clearer images. Further, because the LCDs, that have display characteristics of a conventional hold type, are easy on the eyes, thin, and low in power consumption, the LCDs find wide application from notebook personal computers and liquid crystal monitors to liquid crystal televisions. In the LCDs, however, contrast declines due to leakage of light from a backlight during the display of black color, which is a problem to be solved. Accordingly, there is still a need to further improve the LCDs. On the other hand, PDPs which are of self-emission type can respond at high speed, suppress a black level, and realize a high contrast. In this respect, it can be expected that image quality of the PDPs will improved more greatly than that of the LCDs. However, because of the self-emission type, the PDPs also have a problem to be solved that image burn-in occurs when light emission frequencies or light emission intensity levels are significantly uneven among pixels. Thus, there is also a need to improve the PDPs.

Although organic EL displays which are of the same self-emission type have a similar burn-in problem, the organic EL displays have a faster response speed, leading to realization of further improvement in quality of images including moving images. In addition, because the organic EL displays can be driven through an active matrix similarly to the LCDs, it can be expected that the organic EL displays will be applied to a variety of uses from portable terminals to large-screen televisions.

On the other hand, electronic paper is capable of displaying images without consuming electric power after the images are once written, thereby having an excellent feature of extremely low power consumption. However, because of the use of reflected light, the electronic paper is not available in dark conditions.

At any rate, the above-described flat panel displays are distinguished by their respective display characteristics, and have both advantages and drawbacks of their own. In other words, it is assumed from the nature of the flat panel displays that having, in addition to the characteristics of high brightness, vivid colors, and high contrast, all advantageous performance capabilities of low power consumption, an easy-on-the-eye view, and being free from burn-in is almost impossible.

More information on the flat panel displays is described on pages from 170 to 186 in “Nikkei FPD 2007 <Strategy>” published by Nikkei Business Publications, Inc. in October 2006, whose edition is supervised by NIKKEI MICRODEVICES.

In the world of today where the Internet can be accessed even through a mobile phone, information can easily be collected while freely navigating through Web sites, or images captured by an on-board camera in the mobile phone can be exchanged with others simply via e-mail. Services associated with digital broadcasting such as one-segment broadcasting have being coming into widespread use, which enables users to watch TV programs on a portable terminal anywhere at any time. Now that it has become possible for various types of content to be processed on one terminal, a display capable of displaying a most suitable view for each type of content is desired. In other words, there is a demand for a long-life display that has excellent features of high contrast, high image quality, low power consumption, and suppressed occurrence of image burn-in.

### SUMMARY OF THE INVENTION

In an aspect of the present invention, there is provided a dual display apparatus comprising two displays capable of displaying the same image signal. The two displays differ in display characteristics, and are adapted to usage in which the two displays are switched in accordance with properties of an image signal.

It is preferable that the two displays are configured in a front-and-back-side relationship by integrating the two displays so as to have each display surface placed on an outer side of the dual display apparatus.

It is also preferable that one of the two displays is used to display an image signal representing a natural image, while the other of the two displays is used to display a computer image.

Further, it is preferable that one of the two displays is an organic EL display, and the other of the two displays is a liquid crystal display.

Still further, it is preferable that the two display devices are foldably attached to a main body section in which an operating unit having a plurality of buttons is disposed on one surface of the main body section. When the dual display apparatus is unfolded to enable operation of the operating unit, the liquid crystal display is situated on an operating unit side, and activated. When the dual display apparatus is folded to cover the operating unit, the organic EL display is situated on the outer side of the dual display apparatus, and activated.

In addition, it is preferable that a menu screen on the organic EL display is configured as a screen that has a greater black area and a lower brightness compared with those of a menu screen on the liquid crystal display.

It is preferable that one of the two displays differs in resolution from the other of the two displays.

It is also preferable that the one of the two displays differs in sub-pixel structure for constituting color pixels from the other of the two displays.

Further, it is preferable that one of the two displays is of a delta array type, while the other of the two displays is of a stripe array type.

In another aspect of the present invention, there is provided a dual display apparatus comprising two displays capable of displaying the same picture signal. In the dual display apparatus, pixels of the two displays are usable as a memory for storing display data, and when one of the two displays is used for displaying data, the pixels in the other of the two display devices are put to use as the memory for storing the display data.

In addition, it is preferable that the two displays are organic EL displays.

Further, it is preferable that each pixel of the organic EL displays has a static memory installed therein.

Still further, it is preferable that, among the pixels of the organic EL displays, RGB pixels of one of the organic EL displays are respectively composed of different organic EL materials, while RGB pixels of the other of the organic EL displays are composed of a white organic EL material and a color filter.

In addition, it is preferable that a sealing substrate is shared by both of the displays.

Further, it is preferable that the pixel usable as the memory is driven at a voltage different from that applied at the time of displaying data, thereby causing the pixel to operate consuming lower electric power while the pixel is being used as a part of the memory for the display data.

As described above, provision of the two displays according to the present invention enables suitable display operation that meets various requirements to display data for making full use of the characteristics of the two displays.

### BRIEF DESCRIPTION OF THE DRAWINGS

Preferred embodiments of the present invention will be described in detail based on the following figures, wherein:

FIG. 1 shows a portable terminal having a dual display apparatus mounted therein;

FIG. 2 shows a personal monitor having the dual display apparatus mounted therein;

FIG. 3 shows a configuration of a display system for the dual display apparatus;

FIG. 4A shows deterioration characteristics of a brightness level and a drive voltage of an organic EL element with respect to time;

FIG. 4B shows current-voltage (I-V) characteristics of the organic EL element having been deteriorated under different stress conditions;

FIG. 5A shows a one-bit dynamic memory pixel circuit;

FIG. 5B shows a one-bit static memory pixel circuit;

FIG. 6 shows a unit pixel having a 6-bit DA conversion function;

FIG. 7 shows a configuration of a display system in a dual-sided organic EL display; and

FIG. 8 shows a bonding structure of the dual-sided organic EL display.

### DESCRIPTION OF THE PREFERRED EMBODIMENTS

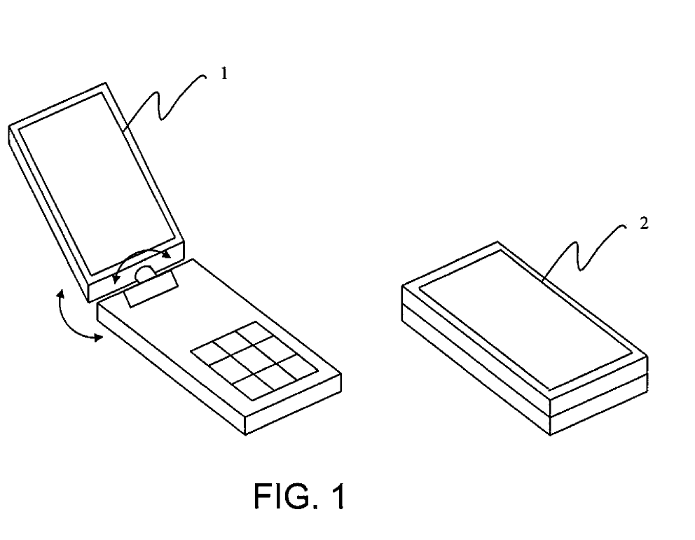

FIG. 1 shows an example of a portable terminal having a first display device 1 and a second display device 2 mounted therein. The first display device 1 can be, for example, an LCD, while the second display device 2 can be, for example, an organic EL display. Although organic EL displays are divided into a passive matrix type and an active matrix type, the active matrix type is used in most organic EL displays in view of electrical power consumption and resolution. Therefore, it is assumed that the organic EL display is of the active matrix type in the description below. Further, the portable terminal can be, for example, a mobile telephone. However, the portable terminal is not limited to the mobile telephone, and can be a portable game machine, a digital camera, or the like. Preferably, the portable terminal can have a function of receiving a TV signal and displaying data represented by the received TV signal.

The first and second display devices 1 and 2 mounted in the portable terminal of FIG. 1 are configured in a bonded form in which each display surface of the first and second display devices 1 and 2 is situated on an outer side. More specifically, in this case, when the portable terminal is unfolded, the LCD constituting the first display device 1 displays an image toward a user as an active screen, and when the portable terminal is folded, the organic EL display constituting the second display device 2 is activated. In a state where the portable terminal is unfolded, a keypad which is an inputting and operating unit is usable.

Because frequent keypad operation is necessary for browsing Web sites, managing a schedule, or creating a mail message, etc., the portable terminal is used in the unfolded state. In other words, the LCD constituting the first display device 1 is activated, thereby permitting the user to perform operation using display performance capabilities provided by the LCD. LCDs can easily be configured so as to have a high resolution, and because the LCDs are of a hold type, they are easy on the eyes. Therefore, even when operation of browsing content, editing text data, or the like takes a lot of time, users can continue working for the operation without feeling much stress. Further, because the LCDs are not of the self-emission type, the amount of power consumption remain unchanged even when data having bright content is displayed, for example, when a displayed view is dominated by a white background. Namely, because the amount of power consumption can be maintained substantially constant regardless of the displayed content, battery drain has no dependence on content. Whenever using the LCDs, users are assured of a predetermined length of time to display desired visual data, and are able to continue using the LCDs without concern for image burn-in.

When the function of a one-segment broadcasting TV or a digital camera is utilized, the portable terminal is used in a folded position. In the folded position, the organic EL display constituting the second display device 2 is activated to display visual data such as a received television program or an image captured from the digital camera. Distinct from the LCD, the organic EL display represents true black without emitting light of black level, which can provide its characteristics of high contrast and high image quality. Accordingly, the users can enjoy viewing more true-to-life images.

Electrical power consumed by a self-emission display device, such as the organic EL display, can be reduced more greatly as long as light emission is suppressed to the maximum extent possible. Accordingly, in a case of the use of an organic EL display screen, power consumption can be minimized further by configuring a user interface, such as a menu screen, so as to be dominated by a black color.

In addition, after unfolding the portable terminal of FIG. 1, a hinge joint for connecting the display devices can be rotated to thereby interchange front and back sides of the portable terminal. After that, images displayed on the LCD can be viewed in the folded position, and keypad operation can be performed while viewing a display screen on the organic EL.

However, the LCD is basically located inside the portable terminal when the portable terminal is folded as described above. Therefore, it is preferable that, when the portable terminal is folded, operating buttons for changing a volume level, a channel, and other settings are laid out on an exterior surface of the portable terminal in the folded position, to thereby enable access to necessary operation while remaining in the folded position.

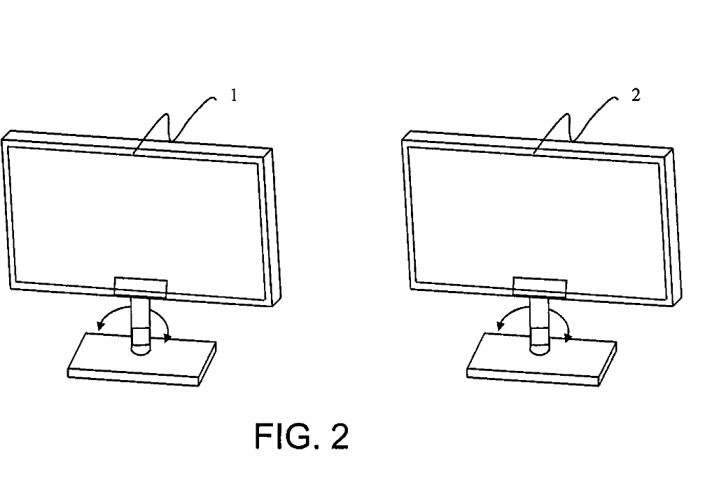

FIG. 2 shows an example of a personal monitor in which, similarly to FIG. 1, display devices having different display characteristics are mounted on both faces of the personal monitor. Similarly to FIG. 1, the first display device 1 can be configured by an LCD, while the second display device 2 can be configured by an organic EL device. In this configuration, the LCD can be utilized to perform a task using a personal computer or the like, while the organic EL display can be utilized to watch a television program or the like and enjoy viewing high quality images. Because the display devices are mounted on both faces, the part to be used can be easily switched between the two display devices by rotating a hinge joint for supporting the display devices. Typically, only a front face side can be activated automatically under normal conditions.

When the first and second display devices 1 and 2 having two different types of display characteristics are installed on the two faces, it becomes possible to select a display device having display characteristics best suited to a supplied service, which in turn enables easy enhancement of performance capabilities of a monitor for the portable terminal or a notebook personal computer or the personal monitor. Further, when the thickness and weight of each of the display devices to be disposed on the two faces are reduced, more compact design can be realized, to thereby permit use of the display devices in a previously available space without any problems. Although it is preferable that each screen of the first and second display devices 1 and 2 has the same size, a slight difference in size between the two screens presents no problem as long as the screens are both capable of displaying the same image signal. In addition, it is also preferable that both of the screens are capable of displaying an image contained within one frame of an image signal.

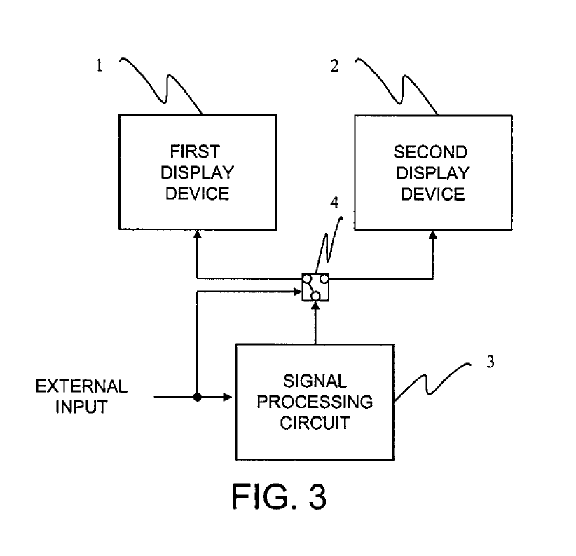

In order to switch the display devices depending on content to be displayed, a display system as shown in FIG. 3 can be implemented. FIG. 3 shows an example of the display system mounted in one display to control a plurality of display devices. When image data and a display device selection signal indicating one of the display devices to be used are supplied from an external host, a signal processing circuit 3 performs signal processing to make the image data compatible with the selected one of the display devices, and then outputs a control signal and the processed image data at a time suitable for the selected one of the display devices. A selector 4 operates to connect the signal processing circuit 3 to the selected one of the display devices according to the display device selection signal, thereby supplying the selected one of the display devices with the image data processed so as to be compatible with the selected one of the display devices together with the control signal.

In the first and second display devices 1 and 2, a driver IC can be mounted as a driving circuit in some cases. However, when a high-performance transistor, such as a low-temperature polysilicon TFT (Thin Film Transistor), is available, a driving circuit can be formed by way of a CMOS (Complementary Metal Oxide Semiconductor) circuit or the like. In this case, the driver IC can be omitted by forming the driving circuit on a panel of the display.

Alternatively, the driver IC can be installed in the display devices, and the function of the signal processing circuit 3 or the selector 4 can be incorporated in the driver IC installed in one of the display devices.

In a display comprising a plurality of display devices which are switched by a single user depending on content to be displayed, such as the monitor for the portable terminal or the notebook personal computer, or the personal monitor, because only one of the plurality of display devices is utilized at one time, one signal processing circuit 3 that receives at least one line of external input can be shared via the selector 4 by the plurality of display devices. The cost of the above-described configuration is lower than the cost of owning two displays each comprising a different type of single display device. When the plurality of display devices are used at a time by multiple users, each of the display devices is intrinsically provided with an external input and the processing circuit 3. The use by the multiple users can be handled by way of the display system shown in FIG. 3 having at least two lines of external inputs while switching the selector 4 alternately at a predetermined timing. In this case, although frame skipping occurs during display of moving image content such as a TV program, images on a personal computer or the like which are updated at a relatively low frequency can be displayed without causing the users to feel something unusual as long as a frequency of switching is sufficiently higher than a frequency of updating.

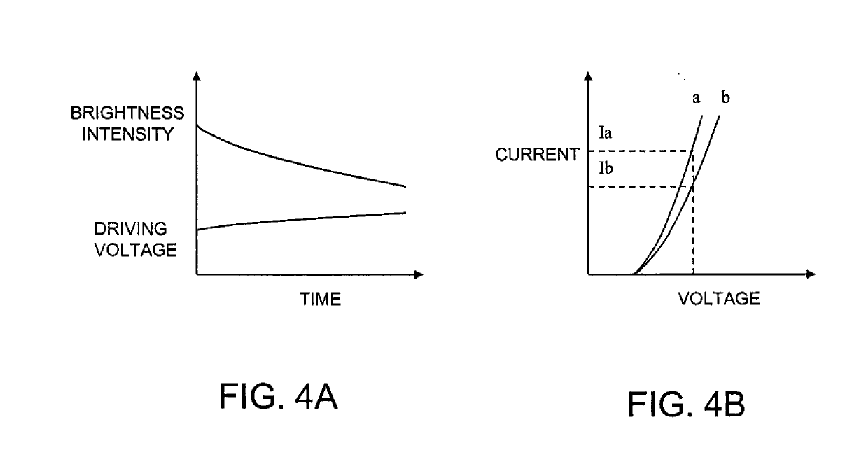

Regarding the portable terminal or the personal monitor intended for use by a single user, there is the possibility that image burn-in would occur when the organic EL display is mounted as one of the plurality of display devices. However, because the frequency of using one of the display devices is lower than that of using a display installed as a solo display, the occurrence of the image burn-in will be reduced compared with that occurring in the solo display. In addition, the image burn-in can be further reduced through processing performed using deterioration characteristics of an organic EL element shown in FIG. 4 as described below.

FIG. 4A shows a relationship in an organic EL element between a degree of brightness deterioration and a rise in voltage caused by increased resistance with respect to time, and FIG. 4B shows current-voltage characteristics of the organic EL element. More specifically, FIG. 4A in which time is plotted on the abscissa, shows a process of changes that occur, while driving with a constant current is continued, in a brightness level and in a driving voltage necessary for feeding the constant current. On the other hand, FIG. 4B shows differences between currents that flow, when voltages plotted on the abscissa are applied, through organic EL elements a and b which have respectively been deteriorated by application of different constant currents.

When the organic EL element is driven by a constant current, there is little effect exerted by the rise in driving voltage. However, as shown in FIG. 4B, when the organic EL element is driven at a constant voltage, a difference between currents arises depending on the degree of deterioration as shown between a current Ia flowing through the organic EL element a and a current Ib flowing through the organic EL element b. Therefore, taking into account reduction in light emitting efficiency of the organic EL element, the burn-in occurs in a short time, thereby affecting display operation.

In order to prevent the burn-in, a constant voltage can be applied to the organic EL elements of all pixels during a period of non-use of the organic El display as the second display device 2. As a result of the constant voltage application, a greater current Ia passes through the organic EL element a which is less deteriorated, while a smaller current Ib passes through the organic EL element b which is more greatly deteriorated. Because the speed of deterioration is accelerated as the current passing through the organic EL element becomes larger, deterioration of the organic EL element a advances faster, while that of the organic EL element b advances more slowly. After a while, because the rate of deterioration of the organic EL element a becomes equal to that of the organic EL element b, it can be expected that the degrees of deterioration are automatically leveled.

The above-described processing can be performed through application of the constant voltage during a non-display period regardless of whether the organic EL elements are driven by the constant current or the constant voltage during a display period.

It is necessary, however, to put some thought into determining an amount of current to be fed at the time of application of the constant voltage, because a smaller amount of current can not have an effect of leveling the degrees of deterioration as expected, while a greater amount of current which can have an excellent effect of leveling the degrees of deterioration will accelerate deterioration as a whole, resulting in darkening of display. With this in view, the amount of current is determined in an adaptive way as described below. Data indicating average brightness, for example, is calculated from image data having been displayed, and based on the data indicating average brightness and data on a displayed time, the degree of deterioration occurring in the pixel is predicted. Then, the amount of current appropriate for deterioration leveling processing is determined according to the predicted result.

For example, when it is assumed that average pixel data at a certain time is D(t), and display operation continues for a time period T, the degree of average brightness deterioration ΔL can be considered at least as

$$Δ L ∝ {\int }_{0}^{T} D ( t ) * d t .$$

Accordingly, when a constant assumed non-display period which is freely estimated in advance is defined as τ, the amount of deterioration leveling current a can be determined so as to satisfy α∝ΔL/τ. The deterioration leveling current a can be obtained by changing the length of a light emission period or a voltage value. When the deterioration leveling current a is changed by varying the voltage value, it is advantageous for the voltage value to be set to a value which brings about a greater difference between the currents. As a result of the above-processing processing, it can be expected that average deterioration stress will be exerted on a pixel which has never emitted light. However, when a resultant value of calculation of the deterioration leveling current is excessively great, the use of the resultant value is unrealistic in terms of the overall reduction of brightness and power consumption. Therefore, an upper limit can be specified.

In conditions where the screen of the organic EL display is viewable from the user, it is preferable that the deterioration leveling processing be performed in a passive way. In other words, a smaller amount of current and a darker screen are desirable. On the other hand, in a case where the user uses the other of the display devices, which is the LCD in this example, without viewing the screen of the organic EL display, the deterioration leveling processing can be performed in a relatively active way. When the organic EL display is installed in the portable terminal or the notebook personal computer as shown in FIG. 1, further active deterioration leveling processing can be performed in conditions where the deterioration leveling processing is unobtrusive to the user and sufficient electrical power is supplied, such as where the portable terminal or the notebook personal computer is being recharged.

Further, a current measuring circuit can be installed in the display system shown in FIG. 3 to measure the amount of current passing through the organic EL element as the display device, and the deterioration leveling current a can be calculated using the measured amount of current in place of the average pixel data D(t).

In addition, a constant voltage can be applied by controlling light emission on a pixel-by-pixel basis, and a pixel current can be measured to extract the degree of deterioration for each pixel, to thereby feed the deterioration leveling current aij (a deterioration leveling current for a pixel ij) through each pixel in accordance with the extracted degree of deterioration. As long as the display screen subjected to the deterioration leveling processing is not viewed from the user, a state in which the measurement is performed while emitting light on the pixel-by-pixel basis does not receive particular attention, and an image that appears through the deterioration leveling processing annoys no one. When the deterioration leveling current is changed for each pixel, the speed of deterioration leveling processing can be accelerated, and deterioration of a pixel which does not have to be deteriorated can be minimized. Besides, because there is no need to emit light over the entire surface, the consumption of electric power can be further reduced.

Also in this case, the deterioration leveling current aij can be changed in accordance with the length of the non-use period. More specifically, the deterioration leveling current aij can be reduced when the assumed non-use period τ is long, or increased when the assumed non-use period τ is short.

When the user resumes the use of the organic EL screen, the deterioration leveling processing which has been in progress is interrupted. At this time, a history of the non-use period can be stored, and the assumed non-use period τ can be updated based on the stored history. For example, when an average non-use period is calculated from the history of several recent non-use periods to determine the assumed non-use period τ, the deterioration leveling processing is performed in a more active way with respect to a user whose average non-use period is short (i.e. a user who often uses the organic EL screen), while the deterioration leveling processing is performed in a more passive way with respect to a user whose average non-use period is long (i.e. a user who does not use the organic EL screen often).

As such, because installation of both of the display devices having different display characteristics, such as a pair of the organic EL display and the LCD, can yield a reduction in the use frequency of the organic EL display while bringing about an increase of the frequency with which the deterioration leveling processing is performed, occurrence of the burn-in caused by deterioration can be suppressed, and the display devices can complement each other with respect to performance capabilities as a display to thereby enhance the display performance as a whole.

In the present embodiment, combination of display devices is not specifically limited. The first display device can be the LCD or electronic paper, while the second display device can be the organic EL display or the LCD. Alternatively, the first and second display devices can be the same type of display devices. Even in the display devices of the same type, when there are differences between resolutions or display characteristics, such as a characteristic as to whether a pixel array is a stripe array or a delta array, the display performance can be increased as a whole. More specifically, because an increased high resolution, which is advantageous in terms of viewability, results in reduction of an aperture ratio, more electric power is consumed to increase brightness. On the other hand, in the strip array, horizontal and vertical lines can be sharply displayed but diagonal lines cannot be displayed smoothly, while more natural display can be realized by way of the delta array. As such, because the types of content to be fitted differ among the display devices, it is preferable that display devices having different display performance capabilities are designed for use in combination in order to handle various types of content.

The same can be applied to driving methods or pixel circuits, which will be described using an example where both of the first and second displays 1 and 2 are organic EL displays.

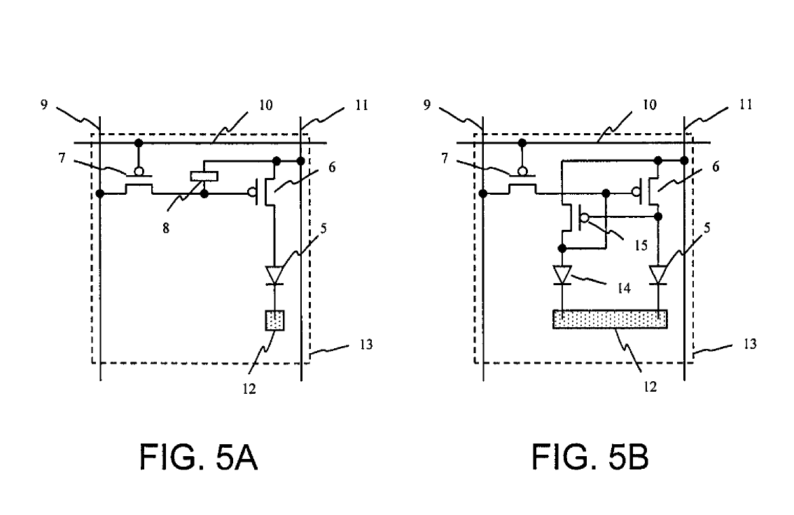

FIGS. 5A and 5B show digital-driving pixel circuits for supplying digital data to pixels, controlling a light emission period or light emission intensity, and performing digital to analog conversion (DA conversion) in the pixels. FIG. 5A depicts a pixel in which the DA conversion is performed through a dynamic circuit, and FIG. 5B depicts a pixel in which the DA conversion is performed through a static circuit.

A pixel circuit 13 shown in FIG. 5A is composed of a (first) organic EL element 5, a (first) drive transistor 6 for driving the organic EL element 5, a gate transistor 7 for incorporating digital data from a data line 9 into the pixel upon application of a selection voltage to a gate line 10, and a holding capacitor 8 for holding the digital data. The organic EL element 5 has a cathode connected to a cathode electrode 12 and an anode connected to a drain terminal of the drive transistor 6, and the drive transistor 6 has a source terminal connected to a power supply line 11 and a gate terminal connected to one end of the holding capacitance 8 and a source terminal of the gate transistor 7. The gate transistor 7 has a gate terminal connected to the gate line 10 and a drain terminal connected to the data line 9. Further, the other end of the holding capacitance 8 is connected to the power supply line 11.

When the selection voltage is supplied to the gate line 10, a low voltage (Low data) only sufficient for turning on the drive transistor 6 is supplied to the holding capacitor 8. Then, an ON current is passed from the power supply line 11 through the organic EL element 5 to the cathode electrode 12, to thereby cause the organic EL element 5 to emit light. When a high voltage (High data) sufficient for turning off the drive transistor 6 is written, the current does not pass through the organic EL element 5, resulting in no light emission in the organic EL element 5. In digital driving, multiple gray levels can be produced by controlling the light emission period or installing a plurality of pixels of FIG. 5 that differ in light emitting area or application voltages. In the pixel shown in FIG. 5A, however, because the data written into the holding capacitor 8 changes over time, it is necessary to repeatedly write the data in a constant cycle.

In a pixel circuit 13 shown in FIG. 5B, the holding capacitor 8 of FIG. 5A is eliminated and a second organic EL element 14 and a second drive transistor 15 are mounted instead. A cathode of the second organic EL element 14 is connected to the cathode electrode 12, while an anode of the second organic EL element 14 is connected to both a drain terminal of the second drive transistor 15 and a connecting point between the gate terminal of the first drive transistor 6 and the gate transistor 7. A gate terminal of the second drive transistor 15 is connected to a connecting point between the first organic EL element 5 and the first drive transistor 6, while a source terminal of the second drive transistor 15 is connected to the power supply line 11.

In the pixel circuit 13 of FIG. 5B, when a write selection voltage (a smaller Low voltage) is supplied to the gate line 10, digital data is written. Once the data is written, because the written data is retained, repetitive writing of the data in the constant cycle is not necessary, differing from the pixel circuit 13 of FIG. 5A. For example, when the Low data is written, the first drive transistor 6 is turned on, and the second drive transistor 15 is turned off. However, because the gate terminal of the first drive transistor 6 is connected to the anode of the second organic EL element 14, the Low voltage is continuously applied via the second organic EL element 14 even after the gate transistor 7 is turned off, thereby maintaining a light emitting state of the first organic EL element 5. Even when the High data is written, the first drive transistor 6 is turned off, while the second drive transistor 15 is turned on, and a current is passed through the second organic EL element 14, thereby causing the second organic EL element 14 to emit light. Here, because an anode voltage of the second organic EL element 14 keeps a gate voltage of the first drive transistor 6 at High even after the gate transistor 7 is turned off, a light non-emitting state of the first organic EL element 5 is maintained. Light emitted from the second organic EL element 14 is shielded by a wiring metal or a black matrix so as not to be leaked to the outside. In this manner, contrast reduction caused by the light emitted from the second organic EL element 14 can be prevented.

When 6 bits of the pixel circuit 13 as shown in FIGS. 5A and 5B are installed, and the organic EL elements 5 which contribute to each light emission of memory pixels 13-0 to 13-5 are configured in such a manner that a ratio of light emission intensity of the organic EL elements 5 stands at 1:2:4:8:16:32, 6-bit gradation can be produced by performing the DA conversion in the pixel circuit 13.

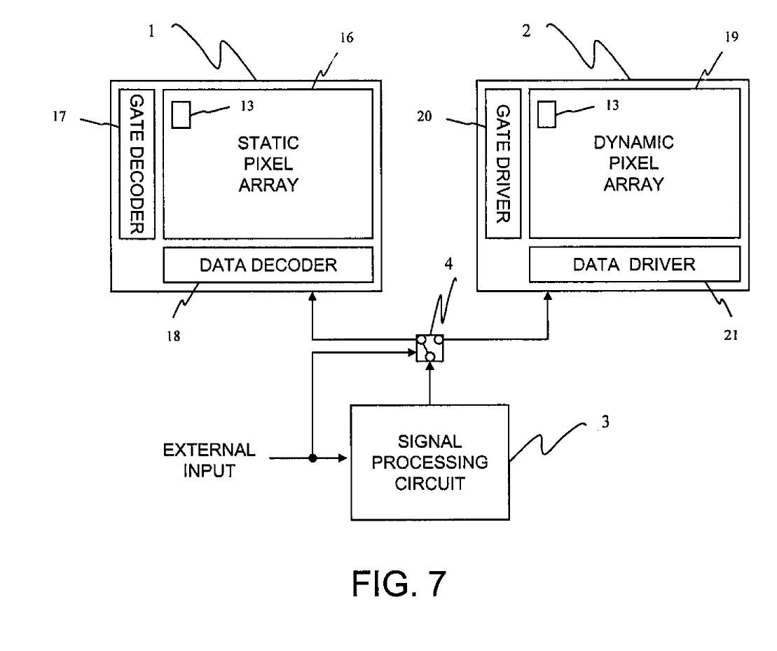

FIG. 7 shows an example of a display system for a dual-sided organic EL display (the dual display apparatus). In the dual-sided organic El display, a display device comprising a static pixel array 16 in which the pixel circuits 13 of FIG. 5B including a static memory are disposed as unit pixels in an array, a gate decoder 17, and a data decoder 18, is mounted as the first display device 1, while a display device comprising a dynamic pixel array 19 in which the pixel circuits 13 of FIG. 5A including a dynamic memory are disposed as unit pixels in an array, a gate driver 20, and a data driver 21, is mounted as the second display device 2.

Assuming that the first display device 1 mainly provides many interactive views associated with operation through the keypad, the static pixel array which does not need regular updating is employed in the first display device 1 because the display of an image is renewed through processing triggered by a user action. When data in the pixel circuits 13 each including the static memory is updated, the gate decoder 17 selects corresponding one(s) of the gate lines 10, and the data decoder 18 supplies data only in a corresponding column to the gate line 9, to thereby rewrite data in a memory pixel that should be updated. Because there is no need to repetitively update pixel data in a fixed cycle, electrical power consumed by unnecessary data transfer is reduced.

On the other hand, because the second display device 2 displays moving image data such as a television program which is periodically transmitted in a fixed cycle, it is necessary for the second display device 2 that pixel data be regularly rewritten. Accordingly, the pixel circuit 13 including the dynamic memory is sufficient for use in the second display device 2, and sequentially transmitted pixel data is updated in succession from the top to the bottom of the gate lines using the gate driver 20 or the data driver 21 composed of a shift resistor or the like.

In the first display device 1, although a higher degree of color purity is not much needed, it is preferable that image burn-in is less likely to occur because the same image continues to be displayed for a while. Further, a high resolution is desirable. In the second display device 2, although the higher degree of color purity is needed, it can be considered that the rate of the occurrence of the image burn-in is relatively low. Taking into account the characteristics of objects to be displayed on the display devices, an organic EL forming a structure, in which the high resolution can easily be realized and full colors are created using a white color having a relatively longer life, and a color filter can be applied to the first display device 1. On the other hand, a way for respectively forming R (red), G (green), and B (blue) materials to provide light emission properties of excellent color purity can be applied to the second display apparatus 2. As such, different organic EL forming methods can be used for each of the display devices.

In full color generation using the white color and the color filters, subpixels for each pixel are configured as four subpixels in which a white pixel W is added to three RGB subpixels. Such a configuration for generating frequently-used white using one subpixel is effective in reducing power consumption because losses due to the color filter are suppressed. The RGBW subpixel configuration is also effective for the LCD. It should be noted that the subpixel which is added to extend the color gamut can be a color other than white.

While one of the display devices is being used, the other of the display devices enters the non-use period during which the constant voltage is applied to perform the deterioration leveling processing. In a case where the organic EL displays are mounted on both sides, there is a fear that image burn-in will occur. However, because a frequency of use is distributed among the two display devices, the occurrence of the image burn-in per one display device is not merely suppressed more greatly than that which occurs in a case where only a single display device is used, but is suppressed even more by increased opportunities to perform the deterioration leveling processing during the non-use period.

During the deterioration leveling processing, the gate lines 10 are selected in sequence, or all of the gate lines 10 are selected at the same time, and, in the meantime, the Low data is supplied to the data lines 9 at a time, which causes the organic EL elements 5 of all the pixels to emit light at the constant voltage. Application of the constant voltage stops by switching the data lines 9 from Low to High while maintaining the selected gate lines 10. When this processing is repeated in longer cycles, the deterioration leveling processing is performed while causing the organic EL elements to flash on and off. On the other hand, when the processing is repeated in shorter cycles, the deterioration leveling processing is performed while displaying a halftone. Because the deterioration leveling current can be varied by changing a duty cycle of turning light on and off, it is possible to control the deterioration leveling current depending on the length of the non-use period as described above.

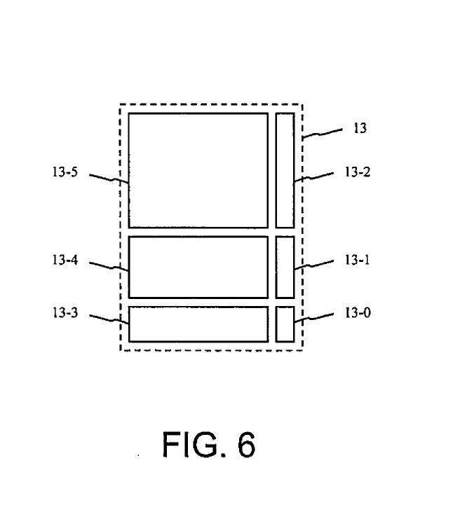

Because provision of the multibit memory pixels 13-0 to 13-5 as shown in FIG. 6 in the unit pixel eliminates the need for installing a frame memory in the signal processing circuit 3 or the like, the manufacturing cost can be reduced. In particular, because a display having a plurality of display devices mounted therein tends to include a greater number of components, resulting in an increase of its manufacturing cost, cost reduction is of importance for the display. An advantageous feature of digital driving is a capability of effectively using a device which can operate at high speed, such as a low-temperature polysilicon TFT. Especially when the low-temperature polysilicon TFT is used, digital circuits, such as the gate decoder 17, the data decoder 18, the gate driver 20, and the data driver 21, can be formed on the same substrate where the memory pixels are formed, which can eliminate the need to provide the driver IC and contribute to cost reduction.

Alternatively, the driver IC can be installed in only one of the display devices, and the functions of the signal processing circuit 3 and the selector 4 can be incorporated into the driver IC, to thereby control the other of the display devices while sharing resources such as the frame memory. Such an arrangement is useful in a case where one of the display devices is of analog driving type, and the other of the display devices is of digital driving type. The reason why the arrangement is useful is that, in the analog driving type, because the DA converter is needed on the part of the data driver, it is easier to implement the DA converter as the driver IC. When a way for controlling the other of the display devices is provided by incorporating the signal processing circuit 3 and the selector 4 in the driver IC, even a combination of display devices that supply different signals to the pixels can be manufactured at lower cost.

Still alternatively, the data driver for performing DA conversion can be formed of an analog circuit using the low-temperature polysilicon TFT, and the driver IC can be installed in one of the display devices which is of the digital driving type. Then, the signal processing circuit 3 and the selector 4 can be incorporated in the one of the display devices having the driver IC, to thereby control the other of the display devices. It should be noted that, during the analog driving, the organic EL pixel circuit as shown in FIG. 5A uses the drive transistor 6 as a constant current source and writes an analog voltage in the holding capacitor 8, to thereby perform current driving of the organic EL element 5.

When both a compact size and high definition are required, as in the case of the portable terminal shown in FIG. 1, it is difficult to incorporate multiple bits into one unit pixel as shown in FIG. 6. In this case, it is desirable that the pixel circuit 13 in the one unit pixel is configured, for example, as one bit, and the signal processing circuit 3 or a combination of the data decoder 18 and the data driver 21 is configured as the driver IC. Then, the frame memory is installed in the driver IC to control the light emission period using sub-frames, thereby realizing multiple gray levels. One of the display devices is configured so as to have high definition with the digital driving using the sub-frames, while the other of the display devices is configured to be memoryless by incorporating multiple bits in one unit pixel, to thereby realize cost reduction.

The static memory pixel shown in FIG. 5B can read out data retained in the gate terminal of the first drive transistor 6 onto the data line 9 by precharging the data line 9 to the Low, and supplying the gate line 10 with a readout selection voltage (a higher Low voltage) which differs from the voltage applied at the time of writing. In a period during which the gate terminal of the first drive transistor 6 is maintained at High, the first drive transistor 6 remains off while the second drive transistor 15 remains on. However, turning on the gate transistor 7 through application of the higher readout selection voltage in that period causes the data line 9 to be connected to the gate terminal of the first drive transistor 6 due to an on-resistance higher than a resistance in the second drive transistor 15. As a result of the connection, a current is passed through the second drive transistor 15 from the power supply line 11 while maintaining the gate terminal of the first drive transistor 6 at High, which causes the data line 9 to be charged from Low to High, so that the data is read out.

On the other hand, in a period during which the gate terminal of the first drive transistor 6 is maintained at Low, the first drive transistor 6 remains on, while the second drive transistor 15 remains off. In this period, however, turning on the gate transistor 7 provides no change to the data line 9. Therefore, after a predetermined time has elapsed, a potential of the data line 9 is read out to determine whether the Low data or the High data is retained. When the potential remains Low, retention of the Low data is determined, and when the potential has changed to High, retention of the High data is determined.

Because data can be read out by installing the memory pixel shown in FIG. 5B, provision of an external frame memory can be eliminated.

For example, when static pixel arrays having the same number of unit pixels are respectively installed in both the first and second display devices 1 and 2, it becomes possible, while one of the first and second display devices 1 and 2 is being used for displaying data, for the other of the first and second display devices 1 and 2 to be used as a memory device. With this configuration, assuming that a 3-bit memory pixel is provided for each one unit pixel, a 6-bit gray level can be displayed using the 3-bit memory pixel mounted in the other of the first and second display devices 1 and 2 which is not in use for displaying, without installing an external memory.

Similarly, even in a case where the one of the display devices is the LCD, the static pixel array consisting of the memory pixels of FIG. 5B can be used as the memory device so as to function as a part of the frame memory, which can lead to elimination of a part of the frame memory to be used for displaying data on the LCD. In addition, a static memory can be installed in the pixel of the LCD, and the static memory can be used as a part of a display memory while the organic EL display performs display operation.

In any of the above-described examples where the static pixel array is used as a memory device for storing information rather than as a display device, the organic EL elements are emitted according to the stored information, which results in additional power consumption. The unnecessary light emission also contributes to deterioration of the organic EL elements. Accordingly, in order to circumvent the additional power consumption and deterioration, it is desirable for the voltage applied to the organic EL elements to be lowered to a minimal level necessary for performing operation as a memory pixel with the objective of minimizing the amount of current passing through the organic EL elements, thereby operating the organic EL elements at the lowered voltage only during the use of the organic EL elements as the memory device.

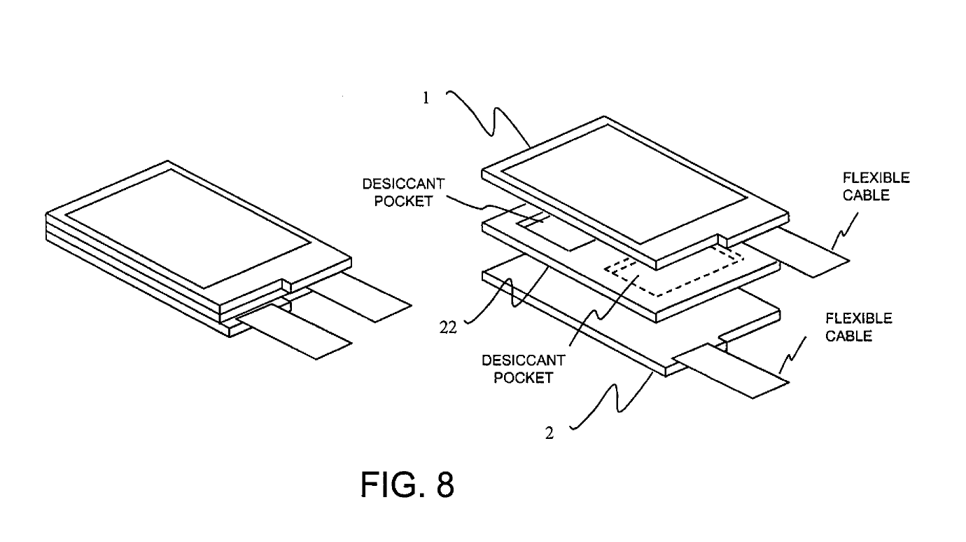

FIG. 8 shows an overall configuration of a dual-sided organic EL display module. Conventionally, there is provided a formation in which two glass substrates that consist of a display device glass substrate having transistors and organic EL elements formed on one side thereof, and a sealing glass substrate having a desiccant pocket formed on one side thereof in which a desiccant is included, are bonded and sealed at the circumference of the glass substrates. The formation can be applied to appropriately sealing the display devices provided on both sides. More specifically, after preparing a sealing glass substrate 22 having desiccant pockets formed on both sides thereof, desiccants are inserted in the desiccant pockets on both sides, and glass substrates for the display devices 1 and 2 are bonded so as to sandwich the sealing glass substrate 22 from both sides of the sealing substrate 22. Then, the circumferences of both of the glass substrates are sealed. In this manner, a sealing effect similar to a conventional sealing effect can be expected from the three glass substrates. After that, flexible cables for supplying image signals and control signals are press-fitted to each of the glass substrates constituting the display devices 1 and 2, to complete the module shown in FIG. 8.

When the organic EL display is used as the display device, the display device can be formed on a single glass substrate, which can make the module extremely thin. Because the personal monitor shown in FIG. 2 can be manufactured in a similar way, the thickness of even an upsized dual-sided organic EL display can be reduced.

Regarding the LCDs, it is possible to form a thin dual-sided LCD (the dual display apparatus) by sharing a backlight between the LCDs on the front and back sides. However, because some of the light illuminated from the shared backlight is used in the other LCD which is not put to use, the backlight to be shared must be brighter than that used in a single-side LCD, which leads to the effect of the sharing being insignificant. Accordingly, when the dual-sided display apparatus is configured using an organic EL display for either one of the display devices, the thickness of the module can be reduced more greatly.

The description having been provided above can similarly be applied to any types of substrates including a glass substrate and a plastic substrate, and is independent of types of semiconductor material used for forming the pixel circuit. Further, the description has no dependence on whether the display devices is of transmissive type or of reflective type.

In addition, in the configuration of the dual display apparatus, the display devices do not have to be bonded directly to each other, and can be formed into a module using a radiator plate or a driving circuit substrate inserted in-between.

The invention has been described in detail with particular reference to certain preferred embodiments thereof, but it will be understood that variations and modifications can be effected within the spirit and scope of the invention.

### PARTS LIST

1 first display device
2 second display device
3 signal processing circuit
4 selector
5 element
6 drive transistor
7 gate transistor
8 holding capacitor
9 data line
10 gate line
11 power supply line
12 cathode electrode
13 pixel circuit
14 element
15 second drive transistor
16 static pixel array
17 gate decoder
18 data decoder
19 dynamic pixel array
20 gate driver
21 data driver
22 sealing glass substrate

1. A dual display apparatus comprising:
two activable displays capable of displaying an image signal, wherein the two displays differ in display characteristics; and
means for activating one of the displays in accordance with properties of an image signal.

2. The dual display device according to claim 1, wherein:
the two displays are configured in a front-and-back-side relationship by integrating the two displays so as to have each display surface of the two displays placed on an outer side.

3. The dual display apparatus according to claim 1, wherein:
one of the displays is used for displaying an image signal representing a natural image, while the other of the displays is used for displaying a computer image.

4. The dual display apparatus according to claim 1, wherein:
one of the displays is an organic EL display, while the other of the displays is a liquid crystal display.

5. The dual display apparatus according to claim 4, including a main body section wherein:
the displays are foldably attached to the main body section providing an operating unit having a plurality of buttons on one surface of the main body section;
means responsive when the dual display apparatus is unfolded to enable operation of the operating unit, the liquid crystal display is situated on an operating unit side, and activated, and
when the dual display apparatus is folded to cover the operating unit, the organic EL display is situated on the outer side of the dual display apparatus, and activated.

6. The dual display apparatus according to claim 4, wherein:
a menu screen of the organic EL display is configured as a screen that has a greater black area and a lower brightness compared with those of a menu screen for the liquid crystal display.

7. The dual display apparatus according to claim 1, wherein:
the one of the displays differs in resolution from the other of the displays.

8. The dual display apparatus according to claim 1, wherein:
the one of the displays differs in a subpixel structure for forming color pixels from the other of the displays.

9. The dual display apparatus according to claim 1, wherein:
the one of the displays is of a delta array type, while the other of the displays is of a stripe array type.

10. A dual display apparatus comprising:
two displays capable of displaying the same signal, wherein:
pixels in the two displays are usable as a memory for storing display data; and
while one of the two displays is being used for displaying data, the pixel in the other of the two displays is used as the memory for storing display data.

11. The dual display apparatus according to claim 10, wherein:
the two displays are organic EL displays.

12. The dual display apparatus according to claim 11, wherein:
a static memory is installed in each pixel of the organic EL displays.

13. The dual display apparatus according to claim 11, wherein:
in the pixels of the organic EL displays, RGB pixels of one of the organic EL displays are respectively composed of different organic EL materials, while the RGB pixels of the other of the organic EL displays are formed of a white organic EL material and a color filter.

14. The dual display apparatus according to claim 11, wherein:
a sealing substrate is shared by both of the organic EL displays.

15. The dual display apparatus according to claim 10, wherein:
means for driving the pixel usable as the memory at a voltage different from that applied at the time of displaying data while the pixel is being used as a part of the memory for the display data.
